(19) United States
(12) Patent Application Publication
(10) Pub. No.: US 2007/0062882 A1
(43) Pub. Date: Mar. 22, 2007

(54) Method to control odors from dewatered biosolids cake

(75) Inventors: Gregory Matthew Adams, Corona del Mar, CA (US); Yen-Chih Chen, Lewisburg, PA (US); Robert Harold Forbes JR., Waxhaw, NC (US); Matthew John Higgins, Lewisburg, PA (US); John Thomas Novak, Blacksburg, VA (US); Jay Robert Witherspoon, Seattle, WA (US)

Correspondence Address: ROBERT D. VARITZ, P.C., 4915 S.E. 33RD PLACE, PORTLAND, OR, 97202, US

(73) Assignee: Water Environment Research Foundation

(21) Appl. No.: 11/523,980

(22) Filed: Sep. 19, 2006

Related U.S. Application Data
(60) Provisional application No. 60/720,106, filed on Sep. 22, 2005.

(51) Int. Cl. C02F 11/12

(52) U.S. Cl. 210/749; 210/916

(57) ABSTRACT

A method of reducing odors from dewatered biosolids cake includes adding an aluminum-containing compound to digested wastewater sludge prior to dewatering, thereby binding odor-causing proteins with the aluminum-containing compound.

### RELATED APPLICATION

This Application claims priority from U.S. Provisional Patent Application Ser. No. 60/720,106, filed Sep. 22, 2005, for METHOD TO CONTROL OF ODORS FROM DEWATERED BIOSOLIDS CAKE.

### FIELD OF THE INVENTION

This invention relates to control of odors from biosolids, and specifically to the control of odor from a dewatered biosolids cake by the addition of metal-containing compounds.

### BACKGROUND OF THE INVENTION

The causes and potential remedies for odors from anaerobically digested and dewatered biosolids have been studied for some time. A number of experiments recently have been conducted to determine what manner of material may be added to dewatered biosolids cake to reduce odors which emanate therefrom, usually in the form of organic gases and/or sulphur compounds.

Adams et al., Identifying and Controlling the Municipal Wastewater Odor Environment Phase II: Impacts of In-Plant Operational Parameters on Biosolids Odor Quality, Water Environment Research Foundation, Report No. 00HHE5T, (2003), describes a variety of treatment processes for wastewater treatment facilities.

Castillo-Gonzalez et al., Dissimilatory iron reduction and odor indicator abatement by biofilm communities in swine manure microcosms, Applied and Environmental Microbiology 71, 9, 4972-4978 (2005) describes use of iron compounds to reduce wastewater odor.

Higgins et al., Cycling of volatile organic sulfur compounds in anaerobically digested biosolids and its implications for odors, Industrial Press, Water Env. Research Vol. 78, No. 3 (March 2006), pp. 243-252, describes various techniques to reduce sulphur emissions from treatment facilities.

Higgins et al., WERF Phase 1: Factors affecting conditioning during dewatering: Sludge and Polymer Characteristics, Proceedings of Water Env. Fed. 77th Annual Conf., New Orleans (2004), and Higgins et al., Part II of Field Research: Impact of Centrifuge Torque and Polymer Dose on Odor Production from Anaerobically Digested Biosolids, Proceedings of WEF/AWWA Joint Residuals and Biosolids Management Conference. Nashville, Tenn. (2005), discuss factors which affect polymer demand during wastewater sludge conditioning.

Muller et al., The Role of Shear in the Generation of Nuisance Odors from Dewatered Biosolids, WEFTEC 2004 Conference and Exhibition Proceedings, New Orleans (2004) describes production of sulphur as the result of shear energy in dewatered biosolids and control of polymer concentration to reduce odor.

Novak et al., Mechanisms of Floc Destruction During Anaerobic and Aerobic Digestion and the Effect on Conditioning and Dewatering of Biosolids, Water Environment Research 37, 3136 (2003) describes types of polymer binding mechanisms in floc.

Park et al., Analysis of Floc Structure and Predicting Sludge Digestability Using Different Cation-Associated EPS Extraction Methods, WEFTEC 2004 Conference and Exhibition Proceedings, New Orleans (2004) describes extraction and analysis of extracellular polymer substances to determine the structure of activated sludge floc.

### SUMMARY OF THE INVENTION

A method of reducing odors from dewatered biosolids cake includes adding an aluminum-containing compound to digested wastewater sludge prior to dewatering, thereby binding odor-causing proteins with the aluminum-containing compound.

It is an object of the method of the invention to reduce the amount of noxious odors generated by dewatered biosolids cake.

Another object of the invention is to reduce the amount of noxious fumes generated by dewatered biosolids cake by the addition of metal-containing compounds.

A further object of the invention is to reduce the amount of noxious fumes generated by dewatered biosolids cake by the addition of aluminum-containing compounds.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 depicts the production profile for TVOSCs for various alum dosages used during conditioning.

FIG. 2 depicts methane production by cakes with different alum dosages used during conditioning.

FIG. 3 depicts average cake solids for different alum dosages used during conditioning.

FIG. 4 depicts optimum polymer dose for increasing alum additions.

FIG. 5 depicts production of TVOSCs during storage for different alum dosages.

FIG. 6 depicts peak TVOSC concentrations from cake samples produced with different alum dosages.

FIG. 7 depicts methane produced from cake samples with different alum dosages.

FIG. 8 depicts mean peak headspace TVOSC versus alum addition.

FIG. 9 depicts odor dilutions-to-threshold (D/T) vs. days from sampling for the full-scale test.

FIG. 10 depicts TVOSC vs. days from sampling for the full-scale test.

FIG. 11 depicts average peak TVOSC concentration from the full-scale test.

FIG. 12 depicts polymer dose vs. various aluminum dosages for the full-scale test.

FIG. 13 depicts average headspace methane concentration vs. sample storage time at designated aluminum dosages for the full scale test.

### DETAILED DESCRIPTION OF THE PREFERRED EMBODIMENTS

The method of the invention includes reduction of odors from dewatered biosolids cake by the addition of metal-containing compounds, and specifically by the addition of aluminum-containing compounds. The experimental data reported herein was derived by treating wastewater sludge with chemicals such as iron, using ferric chloride; calcium oxide, and aluminum, using aluminum sulfate, Al₂(SO₄)₃, which is known as “alum.” A full-scale test has been conducted, and the reports from that test are provided herein.

Laboratory-scale tests on the addition of alum, i.e., aluminum sulfate (Al₂(SO₄)₃, to liquid, digested biosolids along with polymer, such as ClairFloc®, NE-694, manufactured by Polydyne, Inc., of Riceboro, Ga., which polymer is a normal and required coagulant for dewatering biosolids, then subjecting the liquid biosolids to a laboratory-shearing and dewatering protocol. The results of these laboratory experiments appear to confirm that aluminum-containing-containing compounds, e.g., alum, polyaluminum chloride, etc., may be added to reduce odors from dewatered biosolids cake. A description of the method of the invention for mixing is described later herein, in connection with the full-scale test.

The method of the invention was developed initially by conducting several laboratory scale trials using an aluminum sulfate (alum) addition. The trials used a high solids centrifuge simulation procedure (HSCSP) developed to produce cake in the laboratory that had a similar Total Volatile Organic Sulphur Compound (TVOSC), which is analyzed as a surrogate for odors in the headspace of biosolids samples, production as cake samples from full-scale high solids centrifuges. The alum was added prior to a polymer, and the samples were mixed and then dewatered using a laboratory centrifuge. In the first trial, the polymer dose was kept constant because polymer dose has been shown to impact the production of odor causing compounds. In the second trial, the optimum polymer dose (OPD) was found for each alum dose. One potential benefit of alum is that it may be able to lower the polymer dose needed for conditioning. Therefore, the OPD was determined for each alum dose, and a study was performed to determine how the alum addition at optimum polymer dose may impact odorant production. The results from these two trials are provided in the following two sections.

Trial 1: Alum Addition with Constant Polymer Dose

In the first trial, the OPD was determined using a defined mixing regime and capillary suction time as the measure of dewaterability. The sample was anaerobically digested biosolids from Waste Water Treatment Plant (WWTP) 1, which was the Philadelphia, Pa., Biosolids Recycling Center. The Gt-value (gravitational force×time) used for mixing was 100,000. A more detailed explanation of the dewatering experimental setup can be found in Higgins et al. (2004). Once the OPD was determined for the sample, the OPD polymer dose was used for all trials. During the laboratory phase of development of the method of the invention, the alum was added, followed by the polymer and the sample was mixed for 100 seconds at a velocity gradient, G, equal to 1000/s. After conditioning, the samples were dewatered using a laboratory centrifuge, and the cakes were sheared. Following shear, the cake samples were placed in headspace vials, and a headspace analysis procedure was employed. The alum dosages ranged from 0 to 4% by weight of aluminum.

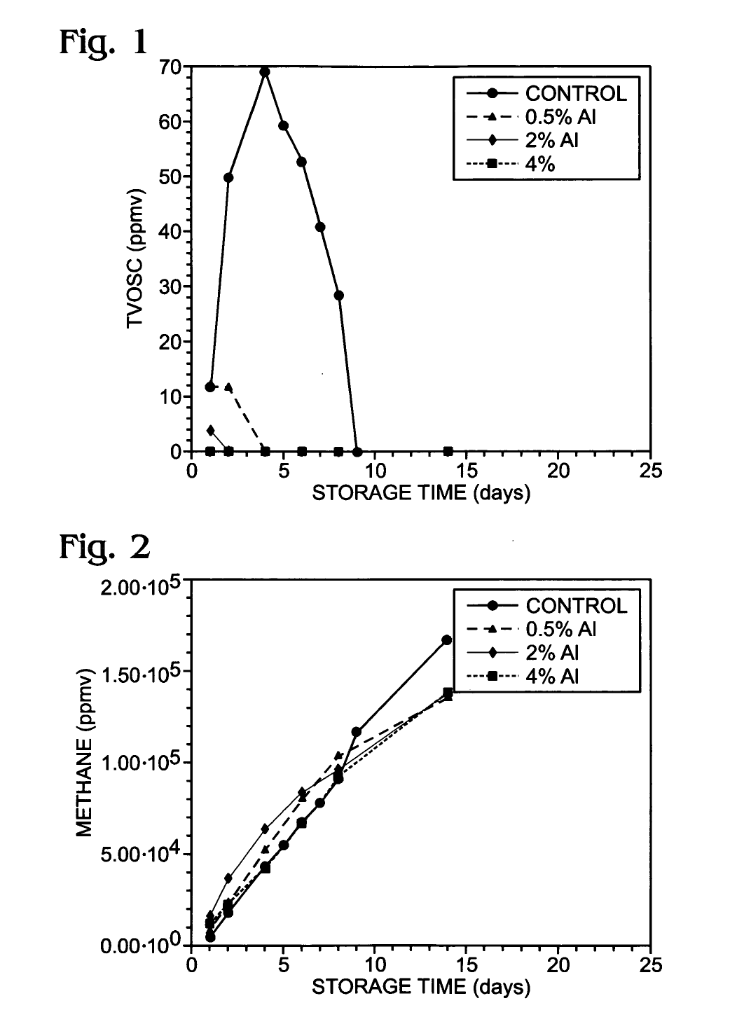

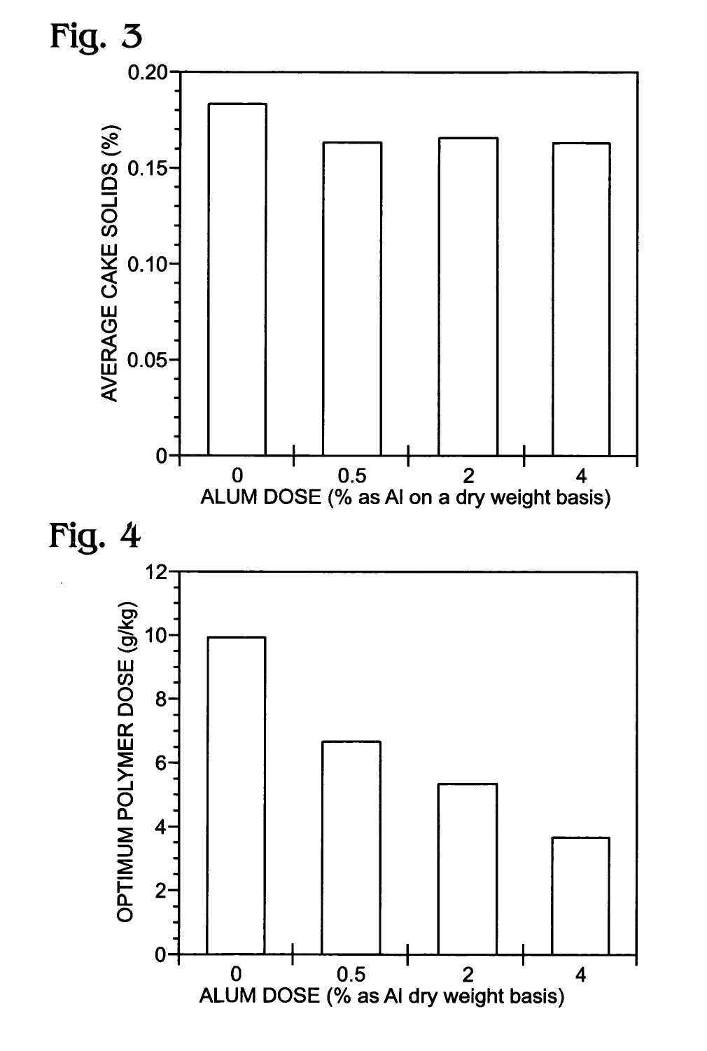

The effect of alum dosage on the TVOSC production profile is shown in FIG. 1. The addition of alum greatly reduced the production of TVOSCs when compared to the control, which did not have alum added thereto. In fact, the lowest dosage examined, e.g., 0.5%, reduced the peak TVOSC concentration by about 83%. The addition of alum did not appreciably affect the methanogenic activity, as shown in FIG. 2, so there appears to have been no inhibitory impacts due to alum addition. It is suspected that the addition of alum reduces the bioavailability of protein, thereby decreasing the biodegradation of protein that leads to the production of odorous compounds. The effect of the alum dosage on the cake solids content is shown in FIG. 3. The addition of alum reduced the cake solids from about 18% to about 16.5%.

Trial 2: Alum Addition with Optimum Polymer Dose

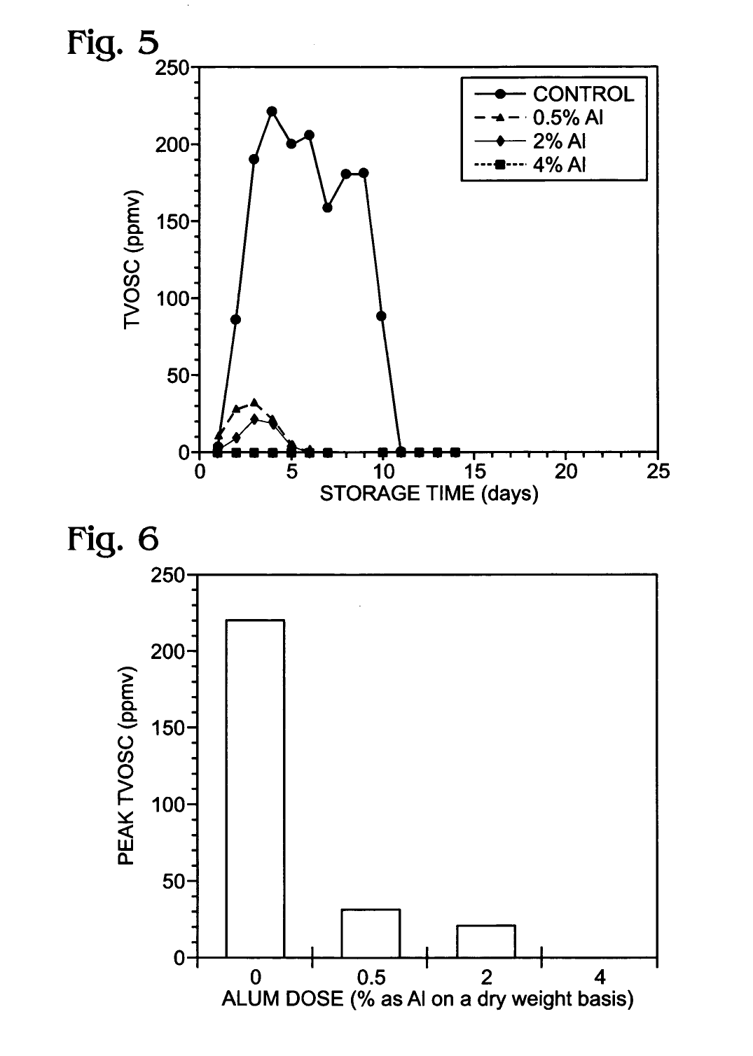

For the second trial, the OPD was determined for each subsequent alum dose, using the same sample as in Trial 1. The OPD for each alum dose is shown in FIG. 4. The increased alum dose resulted in a substantial decrease in the OPD, which may represent an important cost reduction. The effect of the alum on the TVOSC production profile is shown in FIG. 5, and the peak TVOSC measured from each sample is shown in FIG. 6.

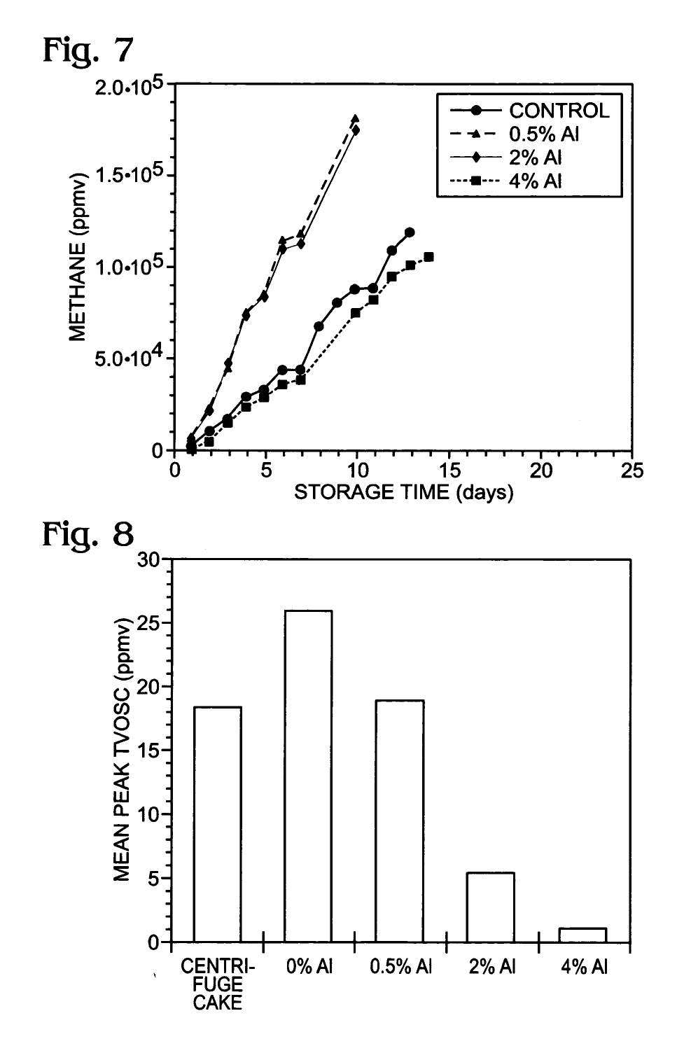

As in Trial 1, the addition of alum resulted in a significant reduction in the peak TVOSC concentration. The methane production increased compared to the control for the first two dosages (0.5 and 2%), and decreased slightly at the highest dosage of 4% compared to the control, as shown in FIG. 7. The results indicate that alum addition in the dosage range used for these trials does not seem to negatively impact beneficial methanogenic activity.

Trial 3: Lab Trial of Alum Addition to Biosolids from a Different WWTP

Biosolids from a different WWTP (San Francisco, Calif., Southeast WWTP) were sampled and taken through alum trials to determine if the effects of alum would produce similar characteristics to the results of the first two trials. Both liquid-digested biosolids and dewatered cake samples were obtained. The liquid biosolids samples were subjected to alum doses ranging from 0% to 4%, i.e., aluminum mass to dry solids mass. The results in terms of Peak TVOSC versus aluminum dose are shown in FIG. 8.

The dewatered cake sample from the WWTP had a lower TVOSC emission than the laboratory-sheared and dewatered sample, indicating that the laboratory shearing device likely exerted higher shear than the full-scale centrifuge. Increasing aluminum dosage rates were once again effective at reducing the Peak TVOSC in the laboratory-dewatered cake. In this trial, the most cost effective aluminum dose appears to be in the range of 2% aluminum to mass of dry biosolids.

It is concluded from these laboratory trials that aluminum added to liquid biosolids ahead of a dewatering centrifuge may result in a substantial decrease in TVOSC emissions from the biosolids cake. The mechanism is believed to be through alum-protein binding, which makes the protein less bioavailable for odorant production.

Results of laboratory-scale experiments indicate that the addition of aluminum in the form of aluminum sulfate (Al₂(SO₄)₃), also known as “alum”, to liquid, digested biosolids prior to dewatering by centrifuges, can significantly decrease the odor potential of dewatered biosolids cake. Odor potential was measured as TVOSC concentration in the laboratory-dewatered sample bottle headspace. The study concluded that TVOSC concentration has a strong correlation with odor level in the off-gases emitted from anaerobically digested and dewatered biosolids cakes. Therefore, the dramatic reductions in headspace concentrations of TVOSC afforded by alum addition are expected to correlate to dramatic reductions in cake odor potential. While the widely available and commercial chemical of aluminum sulfate (alum) was used in these experiments, the method of the invention may incorporate use of any commercial chemical or formulation that contains aluminum.

Full-Scale Trial at Philadelphia Water Department

A full-scale field trial was conducted in July, 2006, during which alum was injected into the biosolids feed of dewatering centrifuges to evaluate its effect on biosolids cake odor reduction.

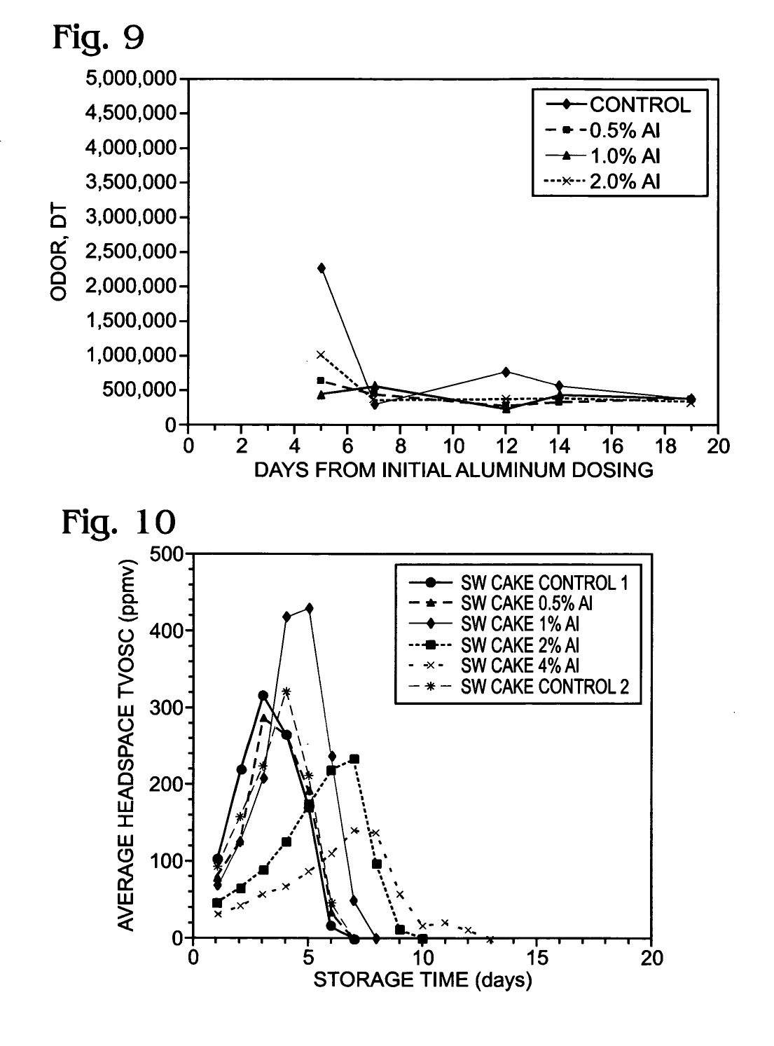

Alum was dosed into the centrifuge feed line through an existing sludge sampling port at gradually increasing dosage rates of 0.5%, 1%, 2% and 4% aluminum to biosolids, on a dry mass ratio basis. After operating the centrifuge for about 45 minutes at each dosage rate, samples of biosolids cake and centrate were obtained and analyzed for a number of constituents. In addition, headspace from the biosolids samples was analyzed on a daily basis for total volatile organic sulfur compounds (TVOSC). Identical headspace samples were analyzed by a certified odor panel in Los Angeles, Calif., with results reported in odor dilutions-to-threshold (D/T) The odor-panel results for samples analyzed on Days 5, 7, 12, 14 & 19 after sampling are shown in FIG. 9. The odor-panel analyses indicate that odors in the cake biosolids were reduced in all samples that were dosed with alum, as compared with the control sample which had no aluminum dose. Identical samples were analyzed daily for headspace TVOSCs, and the results shown in FIG. 10.

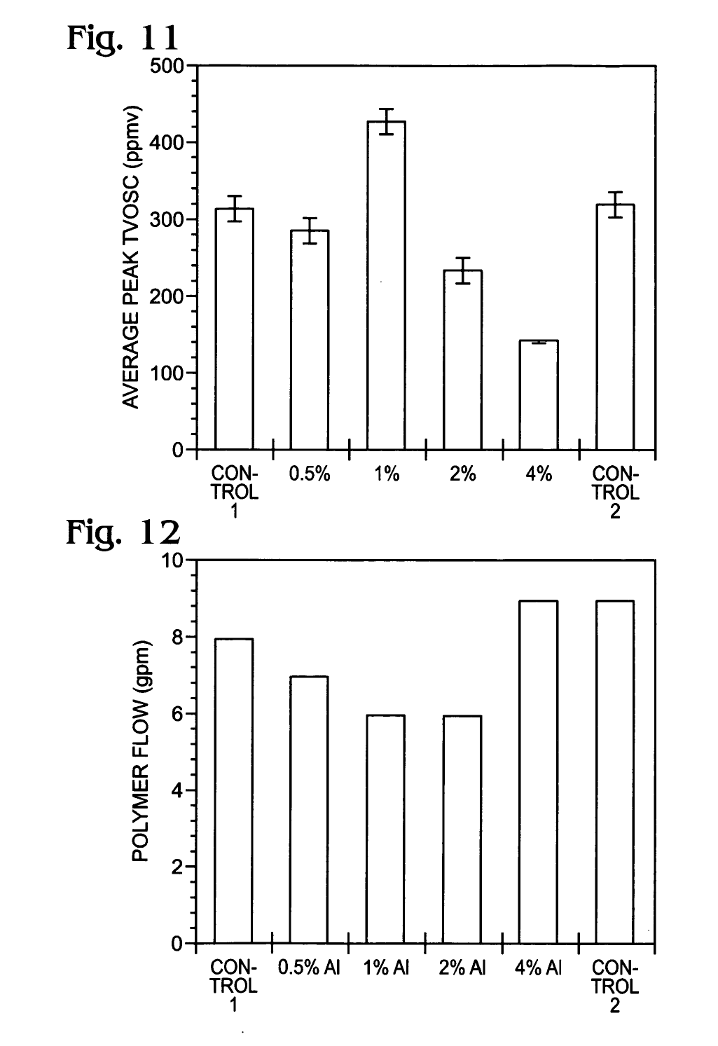

As previously described, TVOSC is used as a surrogate for odors in cake biosolids because it has been shown that reduced organic sulfur is responsible for most biosolids odors, and TVOSC has strong a strong correlation with odor levels in other project experiments. TVOSC is also more precise and sensitive to analyze, thereby revealing differences between different samples more readily. As shown in FIG. 10, headspace TVOSC concentration decreased with increasing aluminum dose, with the exception of the 1%-dose sample. Evaluation of the data indicates that the 1%-dose sample may have been subject to contaminants or sampling errors that were not present in the other samples, for the cake did not dewater well. Also, the SW Cake Control #2 sample results revealed that it had about the same amount of aluminum in it as the 1%-dose sample, because there was apparently an aluminum residue in the centrifuge. The Control #2 sample appeared to be normal, so it could be used in place of the contaminated 1%-dose sample. If that replacement is made and the 1% dose sample is ignored, the plot of average-peak TVOSC concentration versus aluminum dose in FIG. 11 indicates lower headspace TVOSC concentrations with correspondingly higher alum dosages.

A few problems were encountered during this full-scale trial that are expected to be resolved during the course of future investigations. The first and probably most significant problem was the decrease in pH that occurred with increasing alum doses. The pH decreased to 5.6 at the 2% dose and down to 3.9 in the 4% dose. These pH values were low enough to create problems with dewatering and centrate quality, likely because of a detrimental affect on the polymer. Note from FIG. 12 that the polymer dose was reduced at the lower alum doses, but increased at the higher alum doses in a failed attempt to enhance the dewatering process.

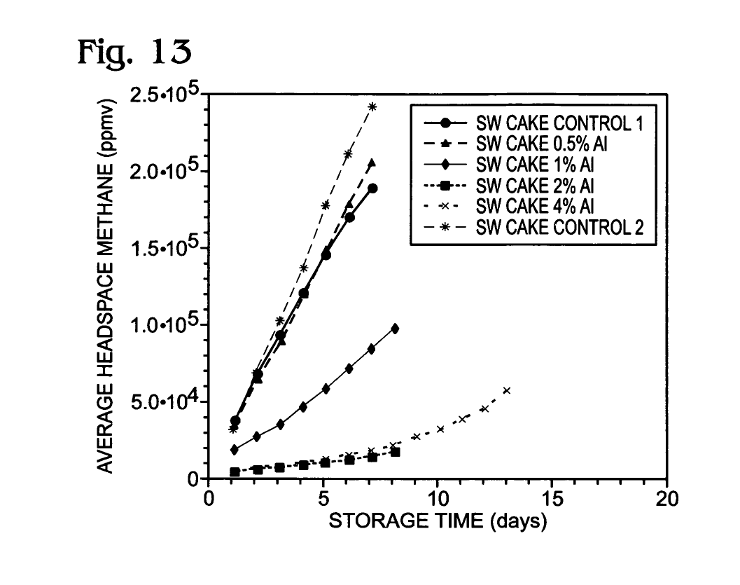

The decrease in pH also created an environment in which methanogens, the beneficial bacteria that consume odors, did not survive well in the biosolids cake samples. As shown in FIG. 13, the survival rate of methanogens, as indicated by headspace methane concentration, was not affected at the 0.5% aluminum dose, but decreased substantially at the higher aluminum doses. Despite the lower methanogen activity, odor levels and TVOSC were lower at the higher aluminum doses. It is thought that if pH can be better controlled, methanogens may be more active and even better odor reduction can be achieved. Better pH control may be achieved by use of polyaluminum chloride as an aluminum-containing compound, or by provision of a base-buffer material. In either potential solution, the goal is to achieve an essentially neutral pH.

Another issue concerns adequate mixing and contact time for the aluminum and the biosolids before entering the centrifuge. The aluminum feed port in the Philadelphia experiment did not promote intense mixing, and contact time prior to entering the centrifuge was less than a minute. Use of more thorough mixing techniques, and provision of a longer contact time may be used to produce more consistent results.

In conclusion, despite the drawbacks of this first, full-scale trial on aluminum, odor-reduction benefits were realized in dewatered biosolids cakes as aluminum doses increased in the feed to a high-solids centrifuge.

It thus appears that addition of aluminum-containing compounds, such a alum or polyaluminum chloride, may be added to dewatered biosolids cake to reduce odors emanating therefrom, and is also useful to reduce polymer demand.

Thus, a method to control of odors from dewatered biosolids cake has been disclosed. It will be appreciated that further variations and modifications thereof may be made within the scope of the invention as defined in the appended claims.

We claim:

1. A method of reducing odors from dewatered biosolids cake comprising,
adding an aluminum-containing compound to digested wastewater sludge prior to dewatering.

2. The method of claim 1 wherein the aluminum-containing compound is Al₂(SO₄)₃.

3. The method of claim 1 wherein the aluminum-containing compound is polyaluminum chloride.

4. The method of claim 1 wherein the concentration of aluminum is between about 0.5% and 4% per dry weight of biosolids.

5. The method of claim 1 which includes binding odor-causing proteins with the aluminum-containing compound.

6. A method of reducing odors from dewatered biosolids cake comprising,
binding odor-causing proteins with an aluminum-containing compound.

7. The method of claim 6 wherein the aluminum-containing compound is Al₂(SO₄)₃.

8. The method of claim 5 wherein the aluminum-containing compound is polyaluminum chloride.

9. The method of claim 6 wherein the concentration of aluminum is between about 0.5% and 4% per dry weight of biosolids.
